(19) United States
(12) Patent Application Publication
(10) Pub. No.: US 2026/0170360 A1
(43) Pub. Date: Jun. 18, 2026

(54) UNIFIED SERVICES PLATFORM FOR INTELLIGENT ENTITY-MATCHING WITH MULTI-MODELS

(71) Applicant: SAP SE, Walldorf (DE)

(72) Inventors: Yi Quan Zhou, Singapore (SG); Rajesh Vellore Arumugam, Singapore (SG); Vaishnavi Inbanathan, Singapore (SG)

(21) Appl. No.: 18/978,073

(22) Filed: Dec. 12, 2024

(51) Int. Cl. G06N 5/04; G06F 16/21

(52) U.S. Cl. CPC G06N 5/04; G06F 16/212

(57) ABSTRACT

Methods, systems, and computer-readable storage media for receiving an inference request including inference data, and determining, from the inference request, that generic line-item matching (GLIM)-based inference is to be executed, and in response, transmitting a GLIM inference request including at least a portion of the inference data and a model identifier, retrieving a GLIM model from a model repository using the model identifier, processing the at least a portion of the inference data through the GLIM model to generate inference results, and returning the inference results to an application.

### BACKGROUND

Enterprises continuously seek to improve and gain efficiencies in their operations. To this end, enterprises employ software systems to support execution of operations. Recently, enterprises have embarked on the journey of so-called intelligent enterprise, which includes automating tasks executed in support of enterprise operations using machine learning (ML) systems. For example, one or more ML models are each trained to perform some task based on training data. Trained ML models are deployed, each receiving input (e.g., a computer-readable document) and providing output (e.g., classification of the computer-readable document) in execution of a task (e.g., document classification task). ML systems can be used in a variety of problem spaces. An example problem space includes autonomous systems that are tasked with matching items of one entity to items of another entity. Examples include, without limitation, matching questions to answers, people to products, bank statements to invoices, and bank statements to customer accounts.

### SUMMARY

Implementations of the present disclosure are directed to a unified services platform that provides a hybrid approach to provisioning data matching services. More particularly, implementations of the present disclosure are directed to a unified services platform that includes an AI-based agent to enable conversational interactions with users to guide users in providing inputs to select between data matching approaches.

In some implementations, actions include receiving a first inference request comprising first inference data, and determining, from the first inference request, that generic line-item matching (GLIM)-based inference is to be executed, and in response, transmitting a GLIM inference request comprising at least a portion of the first inference data and a model identifier, retrieving a GLIM model from a model repository using the model identifier, processing the at least a portion of the first inference data through the GLIM model to generate first inference results, and returning the first inference results to a first application. Other implementations of this aspect include corresponding systems, apparatus, and computer programs, configured to perform the actions of the methods, encoded on computer storage devices.

These and other implementations can each optionally include one or more of the following features: actions further include receiving a request to enable inference for the first application, in response to the request, determining whether training data is available, and in response to training data being available, receiving the training data, training the GLIM model using the training data, storing the GLIM model in the model repository, and providing an entry in an inference registry, the entry including an application identifier that uniquely identifies the first application and the model identifier; the request to enable inference for the first application is received by an AI-based agent that interacts with a user; the first inference request is received by a service gateway; actions further include receiving a second inference request including second inference data, and determining, from the second inference request, that LLM-based inference is to be executed, and in response, transmitting a LLM inference request including at least a portion of the second inference data and a prompt template identifier, retrieving a prompt template from a prompt template repository using the prompt template identifier, generating a prompt using the prompt template and at least a portion of the second inference data, providing the prompt for processing through a LLM to generate second inference results, and returning the second inference results to a second application; actions further include receiving a request to enable inference for the second application, in response to the request, determining whether training data is available, and in response to training data being unavailable, receiving a data schema, a task description, and a set of examples, generating the prompt template based on the data schema, the task description, and the set of examples, storing the prompt template in the prompt template repository, and providing an entry in an inference registry, the entry including an application identifier that uniquely identifies the second application and the prompt template identifier; the request to enable inference for the second application is received by an AI-based agent that interacts with a user; and the second inference request is received by a service gateway.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts portions of example electronic documents.

FIG. 3 depicts an example conceptual architecture in accordance with implementations of the present disclosure.

FIG. 4 depicts example user interfaces in accordance with implementations of the present disclosure.

FIGS. 5A and 5B depict example processes that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to a unified services platform that provides a hybrid approach to provisioning data matching services. More particularly, implementations of the present disclosure are directed to a unified services platform that includes an AI-based agent to enable conversational interactions with users to guide users in providing inputs to select between data matching approaches. For example, if a user has no training data, the user can provide a problem description, a data table schema, and sample matching data through the AI-based agent to enable LLM-based data matching. As another example, if a user provides training data, a training service is triggered to train a ML model on the training data, the ML model being deployed to perform matching tasks.

Implementations can include actions of a first inference request comprising first inference data, and determining, from the first inference request, that generic line-item matching (GLIM)-based inference is to be executed, and in response, transmitting a GLIM inference request comprising at least a portion of the first inference data and a model identifier, retrieving a GLIM model from a model repository using the model identifier, processing the at least a portion of the first inference data through the GLIM model to generate first inference results, and returning the first inference results to a first application. Actions can further include receiving a second inference request including second inference data, and determining, from the second inference request, that large language model (LLM)-based inference is to be executed, and in response, transmitting a LLM inference request including at least a portion of the second inference data and a prompt template identifier, retrieving a prompt template from a prompt template repository using the prompt template identifier, generating a prompt using the prompt template and at least a portion of the second inference data, providing the prompt for processing through a LLM to generate second inference results, and returning the second inference results to a second application.

To provide context for implementations of the present disclosure, enterprises continuously seek to improve and gain efficiencies in their operations. To this end, enterprises employ software systems to support execution of operations. Recently, enterprises have embarked on the journey of so-called intelligent enterprise, which includes automating tasks executed in support of enterprise operations using ML systems. For example, one or more ML models are each trained to perform some task based on training data. Trained ML models are deployed, each receiving input (e.g., a computer-readable document) and providing output (e.g., classification of the computer-readable document) in execution of a task (e.g., document classification task). ML systems can be used in a variety of problem spaces. An example problem space includes autonomous systems that are tasked with matching items of one entity to items of another entity. Examples include, without limitation, matching questions to answers, people to products, bank statements to invoices, and bank statements to customer accounts.

The problem of matching entities represented by computer-readable records (electronic documents) appears in many contexts. Example contexts can include matching product catalogs, deduplicating a materials database, and matching incoming payments from a bank statement table to open invoices. Implementations of the present disclosure are described in further detail with reference to an example problem space that includes the domain of finance and matching bank statements to invoices. More particularly, implementations of the present disclosure are described with reference to the problem of, given a bank statement (e.g., a computer-readable electronic document recording data representative of a bank statement), enabling an autonomous system using a ML model to determine one or more invoices (e.g., computer-readable electronic documents recording data representative of one or more invoices) that are represented in the bank statement. It is contemplated, however, that implementations of the present disclosure can be realized in any appropriate problem space.

Technologies related to artificial intelligence (AI) and ML, AI and ML being used interchangeably herein, have been widely applied in various fields. For example, ML-based decision systems can be used to make decisions on subsequent tasks. With reference to the example context, an ML-based decision system can be used to determine matches between bank statements and invoices. For example, invoices can be cleared in an accounting system by matching invoices to one or more line items in bank statements. In other contexts, decisions on treatment courses of patients (e.g., prescribe/not prescribe a drug) and/or decisions on whether to approve customers for loans can be made based on output of ML-based decision systems. In general, an output of a ML-based decision system can be referred to as a prediction or an inference result. However, the use of ML model in decision systems present unique challenges that did not previously exist in the pre-ML world.

For example, enterprise systems often need to match items (queries) from one table to one or more items (targets) in another table within a database system, Matching is based on inherent relationships within the data. For certain documents, such as tables, this can be referred to as line-item matching. A ML model, referred to as a generic line-item matching (GLIM) model, can be employed to achieve this matching task. For example, a GLIM model is provided as a classifier that is trained to predict entity pairs to a fixed set of class labels (\vec{l}) (e.g., l₀, l₁, l₂). For example, the set of class labels (\vec{l}) can include ‘no match’ (l₀), ‘single match’ (l₁), and ‘multi match’ (l₂). In some examples, the ML model is provided as a function ƒ that maps a query entity (\vec{a}) and a target entity (\vec{b}) into a vector of probabilities (\vec{p}) (also called ‘confidences’ in the deep learning context) for the labels in the set of class labels. This can be represented as:

$$f ( \vec{a} , \vec{b} ) = ( \begin{matrix}{p}_{0} \\ {p}_{1} \\ {p}_{2}\end{matrix} )$$

where \vec{p}={p₀, p₁, p₂}. In some examples, p₀ is a prediction probability (also referred to herein as confidence c) of the item pair \vec{a}, \vec{b} belonging to a first class (e.g., no match), p₁ is a prediction probability of the item pair \vec{a}, \vec{b} belonging to a second class (e.g., single match), and p₂ is a prediction probability of the item pair \vec{a}, \vec{b} belonging to a third class (e.g., multi match).

Here, p₀, p₁, and p₂ can be provided as numerical values indicating a likelihood (confidence) that the item pair \vec{a}, \vec{b} belongs to a respective class. In some examples, the ML model can assign a class to the item pair \vec{a}, \vec{b} based on the values of p₀, p₁, and p₂. In some examples, the ML model can assign the class corresponding to the highest value of p₀, p₁, and p₂. For example, for an entity pair \vec{a}, \vec{b}, the ML model can provide that p₀=0.13, p₁=0.98, and p₂=0.07. Consequently, the ML model can assign the class ‘single match’ (l₁) to the item pair \vec{a}, \vec{b}.

In general, GLIM models are robust when there is sufficient, high quality training data available for training. When training data includes all possible data relations that might be present in the data during inference, the performance of a GLIM model can be good and consistent. However, many enterprises seeking to deploy GLIM models do not have a sufficient amount of training data and/or the quality of training data is insufficient. For example, the training data may be absent data relations that are expected to be seen during inference. This can be mitigated through programmatic approaches or manual processes to prepare training data. However, such approaches are inefficient in terms of time and technical resources consumed and, hence, are impractical. Another approach can include employing large language models (LLMs). However, leveraging LLMs is not only inefficient in terms of time and technical resources, but costly, as cost-incurring calls need to be made to the LLM for each matching task. Hence, this is also impractical.

In view of the above context, implementations of the present disclosure provide a unified services platform that provides a hybrid approach to provisioning data matching services. The hybrid approach includes use of both ML models (GLIM models) and LLMs to address scenarios in which enterprises have insufficient training data in terms of quantity and/or quality. More particularly, and as described in further detail herein, the unified services platform of the present disclosure includes an AI-based agent (e.g., Joule provided by SAP SE of Walldorf, Germany) that enables conversational interactions with users to guide users in providing inputs to select between data matching approaches. For example, if a user has no training data, the user can provide a problem description, a data table schema, and sample matching data through the AI-based agent to enable LLM-based data matching (e.g., using for chain-of-thought (CoT) prompts). As another example, if a user provides training data, a training service is triggered to train a GLIM model on the training data, which can be deployed for inference.

Implementations of the present disclosure are described in further detail herein with reference to an example application that leverages one or more ML models (e.g., GLIM models) to provide functionality (referred to herein as a ML application). The example application includes SAP Cash Application (CashApp) provided by SAP SE of Walldorf, Germany. CashApp leverages ML models (GLIM models) that are trained using a ML architecture (e.g., SAP AI Core) to learn accounting activities and to capture rich detail of customer and country-specific behavior. An example accounting activity can include matching payments indicated in a bank statement to invoices for clearing of the invoices (open invoices). For example, using an enterprise platform (e.g., SAP S/4 HANA), incoming payment information (e.g., recorded in computer-readable bank statements) and open invoice information are passed to a matching engine, and, during inference, one or more GLIM models predict matches between records of a bank statement and invoices. In some examples, matched invoices are either automatically cleared (auto-clearing) or suggested for review by a user (e.g., accounts receivable). Although CashApp is referred to herein for purposes of illustrating implementations of the present disclosure, it is contemplated that implementations of the present disclosure can be realized with any appropriate application that leverages one or more ML models.

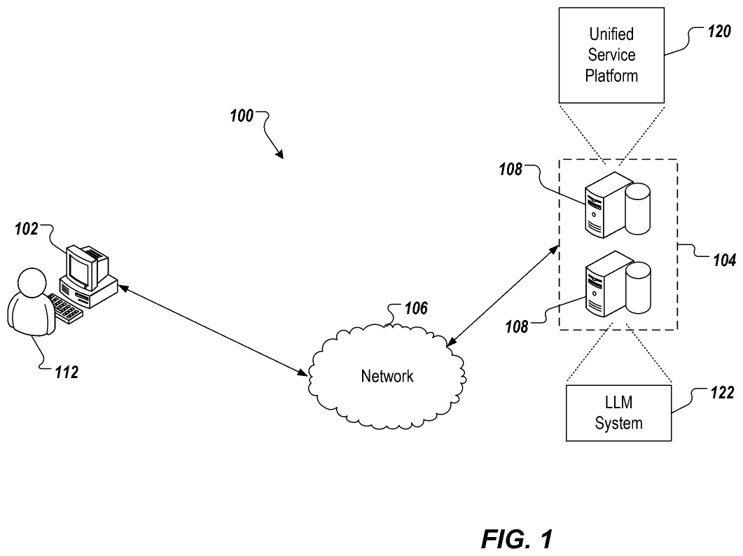

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, the server system 104 can host a ML-based decision system that predicts matches between entities (e.g., CashApp, referenced by way of example herein). Also in accordance with implementations of the present disclosure, the server system 104 can host a unified services platform 120 that users, such as the user 112, can interact with to configure data matching tasks in support of enterprise operations. For example, and as described in further detail herein, the unified services platform 120 includes an AI-based agent (e.g., Joule provided by SAP SE of Walldorf, Germany) that enables conversational interactions with users to guide users in providing inputs to select between data matching using a GLIM model and data matching that leverages a LLM executed within a LLM system 122. In some examples, the LLM and the LLM system 122 can be provided by a third-party (e.g., GPT-4 provided by OpenAI).

Implementations of the present disclosure are described in further detail herein with non-limiting reference to matching bank statement records with invoice records represented in respective electronic documents. It is contemplated, however, that implementations of the present disclosure can be realized for any appropriate data matching tasks (e.g., matching questions to answers, people to products, bank statements to invoices, bank statements to customer accounts).

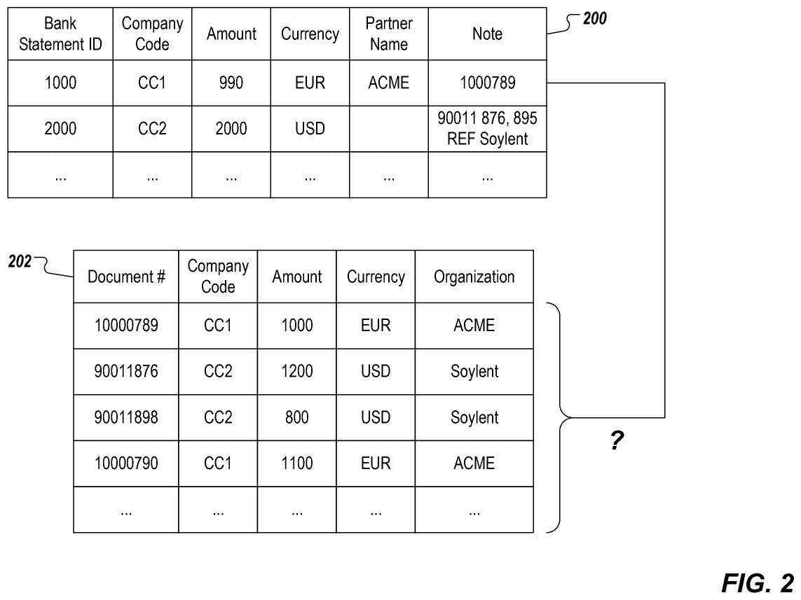

In the example context, FIG. 2 depicts portions of example electronic documents. In the example of FIG. 2, a first electronic document 200 includes a bank statement table that includes records representing payments received, and a second electronic document 202 includes an invoice table that includes invoice records respectively representing invoices that had been issued. In the example context, each bank statement record is to be matched to one or more invoice records. Accordingly, the first electronic document 200 and the second electronic document 202 are processed using one or more ML models that provide predictions regarding matches between a bank statement record (entity) and one or more invoice records (entity/-ies) (e.g., using CashApp, as described above).

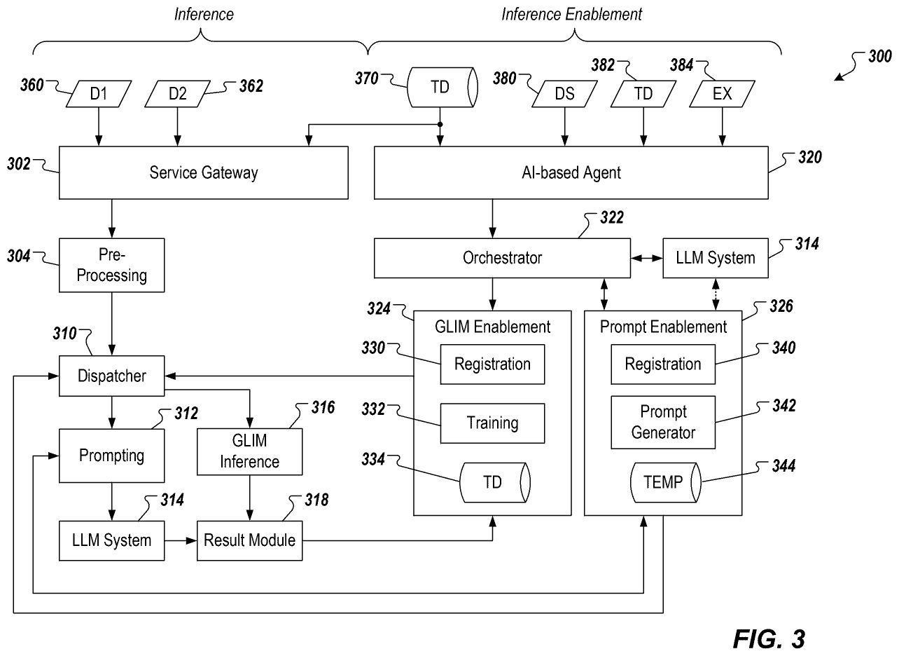

FIG. 3 depicts an example conceptual architecture 300 in accordance with implementations of the present disclosure. In the example of FIG. 3, the conceptual architecture 300 includes inference components and inference enablement components of the unified services platform of the present disclosure. In general, inference components, or at least a portion thereof, execute inference for data matching using GLIM models or LLMs, and inference enablement components, or at least a portion thereof, enable the use of GLIM models or LLMs for inference.

In further detail, in some examples, inference components can include a service gateway 302, a pre-processing module 304, a dispatcher 310, a prompting module 312, a LLM system 314, a GLIM inference module 316, and a result module 318. In some examples, inference enablement components include an AI-based agent 320, an orchestrator 322, a GLIM enablement system 324, and an LLM prompting enablement system 326. In the example of FIG. 3, the GLIM enablement system 324 includes a registration module 330, a training module 332, and a training data repository 334. In the example of FIG. 3, the LLM prompting enablement system 326 includes a registration module 340, a prompt generator 342, and a prompt template repository 344.

In some implementations, electronic documents 360, 362 can be submitted to the unified services platform of the present disclosure to be processed for data matching. Here, the electronic documents 360, 362 can be collectively described as inference data, for which inference is to be performed. In some examples, the electronic document 360 records query items that are to be matched to one or more target items recorded in the electronic document 362. For example, each of the electronic documents 360, 362 can record data representative of entities that are to be matched. For example, and with reference to the non-limiting example above, the electronic document 360 can include a bank statement table that records payments (query items) received and the electronic document 362 can include an invoice table that records invoices (target items) that have been issued, but not yet cleared. In this example, each record of the bank statement table can be matched to one or more records of the invoice table.

In some implementations, the electronic documents 360, 362 are submitted through the service gateway 302. For example, the electronic documents 360, 362, as inference data, are sent from an application (e.g., CashApp) through an application programming interface (API) and the inference data is dispatched to either the GLIM inference module 316 for data matching using a GLIM model or the LLM system 314 for data matching using a LLM. In some implementations, the application submitting the inference data is pre-registered for inference, as described in further detail herein. For example, the inference data can be transmitted to the service gateway 302 using an API call, which can include an application identifier that uniquely identifies the application submitting the inference data.

In some implementations, at least a portion of the inference data is pre-processed by the pre-processing module 304 to filter and reduce a number of entities. For example, invoice records of the invoice table can be filtered to provide sub-set of invoice records that are determined to have a highest likelihood of being matched to bank statement records in the bank statement table. In some examples, the pre-processing module 304 includes, or operates in conjunction with, a retrieval-augmented generation (RAG) service that can generate embeddings of query items and target items, each embedding being a multi-dimensional vector representative of a respective item. In some examples, embeddings can be compared (e.g., using cosine similarity) and pairs of items having a similarity score that exceeds a threshold similarity score can be determined to match and can be removed from the inference data that is to be processed using a GLIM model or a LLM.

In some implementations, the dispatcher 310 receives the pre-processed inference data and determines whether data matching is to be executed using a GLIM model or a LLM. In some examples, the dispatcher 310 can maintain an inference registry (provide by the inference enablement components, as described in further detail herein) that indexes applications to data matching services (e.g., GLIM, LLM) and, for each data matching service, one or more parameters for executing data matching (e.g., for GLIM, a particular GLIM model that is to be used to process the inference data). Accordingly, in response to an application identifier provided with the inference data, the dispatcher 310 can determine how to route the inference data through the inference components (e.g., route the inference data for GLIM data matching of LLM data matching).

If the (pre-processed) inference data is to be processed using a GLIM model for data matching, the dispatcher 310 sends a call to the GLIM inference module 316 (e.g., through an API indicated in the inference registry). The GLIM inference module 316 processes the inference data through a GLIM model (e.g., identified from the inference registry) to generate an inference result. In some examples, the inference result includes a set of matches, each match matching a record of the electronic document 360 (e.g., a payment received) to one or more records of the electronic document 362 (e.g., invoice issued). In some examples, and although not explicitly depicted in FIG. 3, the inference result is returned to the application to perform one or more downstream activities (e.g., automatically clear invoices).

In some implementations, if the (pre-processed) inference data is to be processed using a LLM for data matching, the dispatcher 310 sends a call to the prompting module 312, which generates a prompt based on the inference data and a prompt template (e.g., identified in or provided from the inference registry). For example, the prompting module 312 can maintain a prompt template store and can select a prompt template from the prompt template store based on the application identifier. In some examples, the prompt is generated by populating placeholders with at least a portion of the inference data (e.g., populating placeholders with filenames and/or URLs of each of the electronic documents 360, 362).

In some examples, the prompting module 312 prompts the LLM system 314 using the prompt (e.g., makes a call to the LLM system 314 through an API), which processes the prompt and returns an inference result. In some examples, the inference result includes a set of matches, each match matching a record of the electronic document 360 (e.g., a payment received) to one or more records of the electronic document 362 (e.g., invoice issued). In some examples, and although not explicitly depicted in FIG. 3, the inference result is returned to the application to perform one or more downstream activities (e.g., automatically clear invoices).

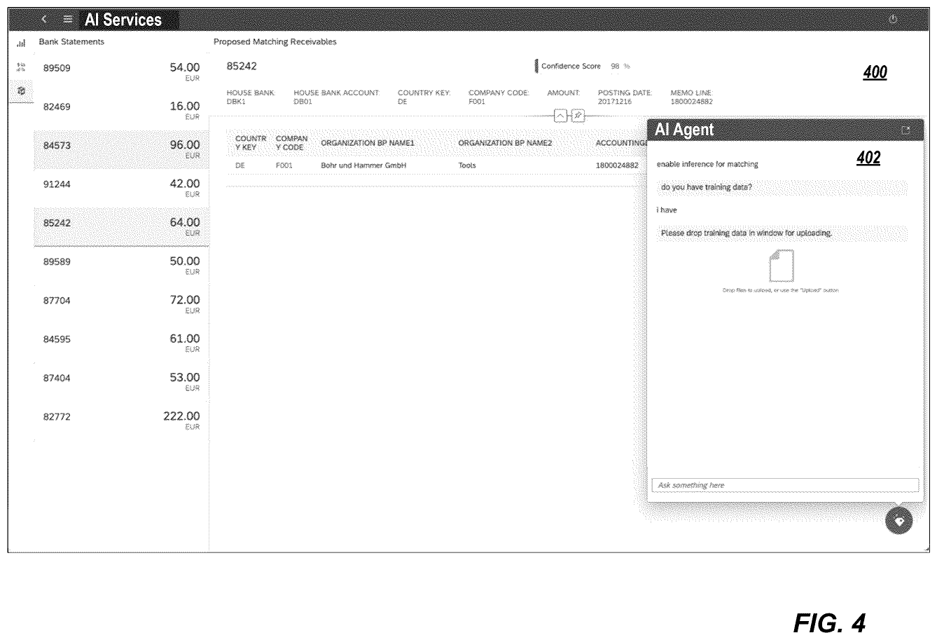

Referring now to inference enablement, prior to inference described herein, a user (e.g., the user 112 of FIG. 1) can interact with the AI-based agent 320 to configure inference-based data matching for an application. For example, the user can be interacting with the application through a user interface (UI), such as a web page. FIG. 4 depicts an example UI 400 of an application that the user can use to interact with the application. In some examples, the user can indicate that inference is to be used for the application. For example, while in the application, the user can trigger interaction with the AI-based agent and, in response, an AI-based agent UI can be displayed over the application UI. FIG. 4 depicts an example AI-based agent UI 402. In some examples, user input to the AI-based agent UI 402 and any actions taken in response to or resulting from the user input can be linked to the application that the user is interacting with (e.g., in the UI 400). For example, the application can be associated with an application identifier that uniquely identifies the application (e.g., and the enterprise that the application is provisioned for). The user input, the actions, and the results can each be linked to the application identifier, as described in further detail herein.

In some examples, the user can converse with the AI-based agent in natural language. For example, the user can input text, in natural language (unstructured text), which can be processed by the AI-based agent to converse with the user. In the context of the present disclosure, the user can indicate to the AI-based agent that the user would like to use inference for data matching. For example, and as depicted in the example of FIG. 4, the user can input “enable inference for data matching” to the AI-based agent UI 402. Here, for example, enablement of inference for data matching can be associated with the application using the application identifier. In response, the AI-based agent can ask the user whether training data is available. For example, and as depicted in the example of FIG. 4, the AI-based agent can response with “do you have training data?” displayed in the AI-based agent UI 402.

In accordance with implementations of the present disclosure, if training data is available, a GLIM model can be trained on the training data and can be deployed for data matching using the GLIM model, as described herein. Also in accordance with implementations of the present disclosure, if training data is unavailable, LLM-based data matching can be enabled by generating a prompt template that can be used to prompt an LLM of the LLM system 314.

With reference to training data being available, in response to the user indicating that training data is available, the AI-based agent 320 can request that the user input training data 370. For example, the user can input the training data 370 by dragging-dropping a file containing the training data 370 into the a UI (e.g., the AI-based agent UI 402). The training data can include data representative of data matching (e.g., multiple instances of bank records each being matched to one or more invoice records). In some examples, in response to receiving the training data 370, the AI-based agent 320 initiates training of a GLIM model using the training data 370.

In some implementations, the AI-based agent 320 sends a request to the orchestrator 322, the request indicating that a GLIM model is to be trained. In some examples, the request can include one or more of an inference type (e.g., indicating GLIM-based inference), an application identifier (e.g., uniquely identifying the application that the request for inference for data matching originated from), and the training data 370. In some examples, in response to the inference type, the orchestrator 322 provides the request to the GLIM enablement system 324, which processes the request to provide a GLIM model that is training on the training data 370.

In some implementations, the registration module 330 generates an entry for the inference registry that represents the GLIM-based inference for the application indicated by the application identifier. In some examples, the entry includes the application identifier, the inference type, and a model identifier that uniquely identifies the GLIM model that is to be used for the application during inference. In some examples, the model identifier can initially be blank, until training of the GLIM model is complete.

In some examples, the training data 370 is stored in the training data repository 334 and is used by the training module 332 to training a GLIM model. In general, the GLIM model is iteratively trained, where, during an iteration, also referred to as epoch, one or more parameters of the GLIM model are adjusted, and an output is generated based on the training data (e.g., class predictions). For each iteration, a loss value is determined based on a loss function. The loss value represents a degree of accuracy of the output of the GLIM model. The loss value can be described as a representation of a degree of difference between the output of the ML model and an expected output of the GLIM model (the expected output being provided from training data). In some examples, if the loss value does not meet an expected value (e.g., is not equal to zero), parameters of the GLIM model are adjusted in another iteration (epoch) of training. In some examples, the iterative training continues for a pre-defined number of iterations (epochs). In some examples, the iterative training continues until the loss value meets the expected value or is within a threshold range of the expected value.

Further details of training ML models (e.g., using training jobs), such as GLIM models, are described in further detail in commonly assigned U.S. application Ser. No. 18/358,225, filed on Jul. 25, 2023, and entitled Large Language Models for Extracting Conversational-Style Explanations for Entity Matches, the disclosure of which is expressly incorporated herein by reference in the entirety for all purposes.

In some implementations, after the GLIM model is trained, the GLIM model can be stored in a ML model repository and indexed based on the model identifier assigned thereto. In some examples, the ML model repository is accessible by the GLIM inference module 316, which can selectively retrieve the GLIM model for inference, as described in detail herein. Further, the entry is updated to include the model identifier and is provided to the dispatcher 310, which updates the inference registry to include the entry. In this manner, the dispatcher 310 can determine that, for the application identified by the application identifier, GLIM-based inference is to be executed using the GLIM model identified by the model identifier.

With reference to training data being unavailable, in response to the user indicating that training data is unavailable, the AI-based agent 320 can request that the user provide a data schema 380, a task description 382, and a set of example data matches 384. In some examples, the data schema 380 is descriptive of the structure of the data as recorded in electronic documents that will be input for inference. For example, for each table that is to be used in a matching task, the data schema 380 can describe what types of records are provided in each row and fields of columns. In some examples, the task description 382 describes the task that a LLM is expected to perform. In the context of the present disclosure, the task is data matching between electronic documents. More particularly, the task is tabular data matching of records of disparate tables. In some examples, the set of example data matches are each an example of a successful match of records between tables. The conditions for a potential match could also be provided with each example. The set of example data matches are used for few-shot learning of the LLM executed by the LLM system 314. Here, few-shot learning (also referred to as in-context learning and/or few-shot prompting) is a prompting technique that enables the LLM to process examples before attempting a task.

In some implementations, the AI-based agent 320 sends a request to the orchestrator 322, the request indicating that a prompt template is to be generated for inference using a LLM. In some examples, the request can include one or more of an inference type (e.g., indicating LLM-based inference), an application identifier (e.g., uniquely identifying the application that the request for inference for data matching originated from), the data schema 380, the task description 382, and the set of example data matches 384. In some examples, in response to the inference type, the orchestrator 322 provides the request to the prompt system 326, which processes the request to provide a prompt template based on the data schema 380, the task description 382, and the set of example data matches 384.

In some implementations, the registration module 340 generates an entry for the inference registry that represents the LLM-based inference for the application indicated by the application identifier. In some examples, the entry includes the application identifier, the inference type, and a prompt template identifier that uniquely identifies the prompt template that is to be used for the application during inference. In some examples, the prompt template identifier can initially be blank, until generation of the prompt template is complete.

In some implementations, the prompt generator 342 generates a prompt template based on the data schema 380, the task description 382, and the set of example data matches 384. For example, the prompt generator 342 can interact with the LLM system 314 to generate the prompt template. In some examples, the prompt template is provided as a CoT prompt template. Here, CoT prompting can be described as a prompt engineering technique that aims to improve the performance of generally trained, non-domain specific LLMs on tasks requiring logic, calculation and decision-making by structuring the prompt in a way that mimics human reasoning. More particularly, CoT prompting is a prompting method used to encourage LLMs to not only output an answer, but also explain to the LLM the steps to be followed to derive the answer. CoT scripts within prompt templates are use-case specific and are crafted for the specific use case, such as tabular data matching.

In some examples, the prompt generator 342 populates a CoT extraction prompt template using the use case data to provide a CoT extraction prompt, prompting a LLM (e.g., the LLM system 314) using the CoT extraction prompt, receiving, from the LLM, a CoT script responsive to the CoT extraction prompt, generating a CoT prompt template using the CoT script, and deploying the inference prompt template for production inference. Further details of generating prompt templates for data matching, such as CoT prompt templates, are described in commonly assigned U.S. application Ser. No. 18/762,792, filed on Jul. 3, 2024, and entitled Generating Chain-of-Thought Prompt Templates Using Multi-Modal Large Language Models for Tabular Data Matching, the disclosure of which is expressly incorporated herein by reference in the entirety for all purposes.

In some implementations, after the prompt template is generated, the prompt template can be stored in the prompt template repository 344 and indexed based on the prompt template identifier assigned thereto. In some examples, the prompt template repository 344 is accessible by the prompting module 312, which can selectively retrieve the prompt template for inference, as described in detail herein. Further, the entry is updated to include the prompt identifier and is provided to the dispatcher 310, which updates the inference registry to include the entry. In this manner, the dispatcher 310 can determine that, for the application identified by the application identifier, LLM-based inference is to be executed using the prompt template identified by the prompt template identifier.

In accordance with implementations of the present disclosure, for each application that inference is to be performed for, an entry is provided in the inference registry maintained by the dispatcher 310. At least a portion of an inference registry can be provided as:

TABLE 1
Example Inference Registry

| Application | Inference Type | GLIM | Prompt Template |
|---|---|---|---|
| A₁ | LLM | — | P_{ABC} |
| A₂ | GLIM | M_{XYZ} | — |
| . . . | . . . | . . . | . . . |
| A_{N} | GLIM | M_{QRS} | — |

For example, in response to receiving a request from application A₁, the dispatcher 310 can use the inference registry to determine that LLM-based inference is to be executed using the prompt template P_{ABC}. As another example, in response to receiving a request from application A₂, the dispatcher 310 can use the inference registry to determine that GLIM-based inference is to be executed using the GLIM model M_{XYZ}.

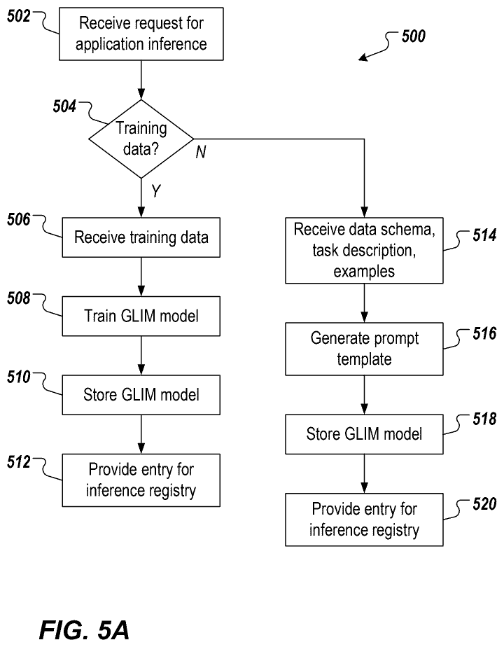

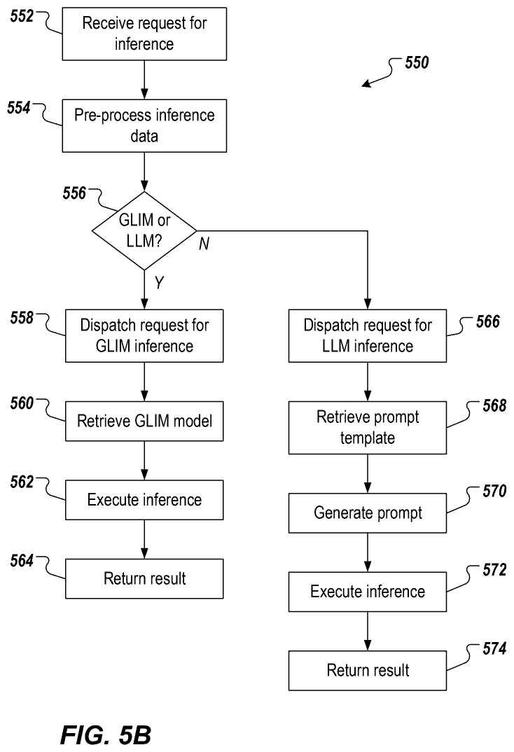

FIG. 5A depicts an example process 500 that can be executed in accordance with implementations of the present disclosure. In some examples, the example process 500 is provided using one or more computer-executable programs executed by one or more computing devices.

A request for application inference is received (502). For example, and as described herein, a user can converse with the AI-based agent 320 and can indicate to the AI-based agent 320 that the user would like to use inference for data matching for an application. It is determined whether training data is available (504). For example, and as described herein, the AI-based agent 320 can ask the user whether training data is available and the user can provide a response.

If training data is available, the training data is received (506). For example, and as described herein, the user can input the training data 370 to the AI-based agent 320 by dragging-dropping a file containing the training data 370 into the a UI (e.g., the AI-based agent UI 402). In some examples, in response to receiving the training data 370, the AI-based agent 320 initiates training of a GLIM model using the training data 370.

A GLIM model is trained (508) and the GLIM model is stored (510). For example, and as described herein, the AI-based agent 320 sends a request to the orchestrator 322, the request indicating that a GLIM model is to be trained. In some examples, the request can include one or more of an inference type (e.g., indicating GLIM-based inference), an application identifier (e.g., uniquely identifying the application that the request for inference for data matching originated from), and the training data 370. In some examples, in response to the inference type, the orchestrator 322 provides the request to the GLIM enablement system 324, which processes the request to provide a GLIM model that is training on the training data 370. The training data 370 is stored in the training data repository 334 and is used by the training module 332 to training a GLIM model. After the GLIM model is trained, the GLIM model can be stored in a ML model repository and indexed based on the model identifier assigned thereto. In some examples, the ML model repository is accessible by the GLIM inference module 316, which can selectively retrieve the GLIM model for inference, as described in detail herein.

An entry for an inference registry is provided (512). For example, and as described herein, an entry is provided by the registration module 330 and includes the application identifier and the model identifier and is provided to the dispatcher 310, which updates the inference registry to include the entry. In this manner, the dispatcher 310 can determine that, for the application identified by the application identifier, GLIM-based inference is to be executed using the GLIM model identified by the model identifier.

If training data is not available, a data schema, a task description, and a set of examples are received (514). For example, and as described herein, in response to the user indicating that training data is unavailable, the AI-based agent 320 can request that the user provide the data schema 380, the task description 382, and the set of example data matches 384. A prompt template is generated (516) and is stored (518). For example, and as described herein, the AI-based agent 320 sends a request to the orchestrator 322, the request indicating that a prompt template is to be generated for inference using a LLM. In some examples, in response to the inference type, the orchestrator 322 provides the request to the prompt system 326, which processes the request to provide a prompt template based on the data schema 380, the task description 382, and the set of example data matches 384.

An entry for an inference registry is provided (520). For example, and as described herein, after the prompt template is generated, the prompt template can be stored in the prompt template repository 344 and indexed based on the prompt template identifier assigned thereto. In some examples, the prompt template repository 344 is accessible by the prompting module 312, which can selectively retrieve the prompt template for inference, as described in detail herein. Further, an entry is provided to include the application identifier and prompt identifier and is provided to the dispatcher 310, which updates the inference registry to include the entry. In this manner, the dispatcher 310 can determine that, for the application identified by the application identifier, LLM-based inference is to be executed using the prompt template identified by the prompt template identifier.

FIG. 5B depicts an example process 550 that can be executed in accordance with implementations of the present disclosure. In some examples, the example process 550 is provided using one or more computer-executable programs executed by one or more computing devices.

A request for inference is received (552). For example, and as described herein, an application (e.g., CashApp) can submit an inference request that includes the electronic documents 360, 362 through the service gateway 302. Inference data is pre-processed (554). For example, and as described herein, the pre-processing module 304 pre-processes the inference data to reduce a size of the inference data to be processed for inference. It is determined whether GLIM-based inference or LLM-based inference is to be executed (556). For example, and as described herein, the dispatch module 310 performs a look-up using an application identifier received with the request to determined whether GLIM-based inference or LLM-based inference is to be used.

If GLIM-based inference is to be executed, a request is dispatched for GLIM-based inference (558). For example, and as described herein, the dispatcher 310 sends a request to the GLIM inference module 316, the request including the inference data and a model identifier. A GLIM model is retrieved (560), inference is executed (562), and inference results are returned (564). For example, and as described herein, the GLIM inference module 316 retrieves a GLIM model from the model repository using the model identifier as an index. The GLIM inference module 316 processes the inference data through the GLIM model and returns inference results. In some examples, the inference results are returned to the application that had issued the inference request.

If LLM-based inference is to be executed, a request is dispatched for LLM-based inference (566). For example, and as described herein, For example, and as described herein, the dispatcher 310 sends a request to the prompting module 312, the request including the inference data and a prompt template identifier. A prompt template is retrieved (568), a prompt is generated (570), inference is executed (572), and inference results are returned (574). For example, and as described herein, the prompting module 312 retrieves a prompt template from the prompt template repository 344, populates at least a portion of the prompt template with the inference data to provide a prompt. The prompting module 312 prompts the LLM system 314 using the prompt and inference results are returned. In some examples, the inference results are returned to the application that had issued the inference request.

Implementations of the present disclosure provide one or more technical advantages. As described in detail herein, the unified service platform of the present disclosure has separate API or integration interfaces for inference and inference enablement. For example, inference requests are received by a service gateway (e.g., through an API call) and inference enablement requests are received through an AI-based agent. This design ensures a transparent and unified integration for disparate applications and application use cases (e.g., use cases that are specific to respective lines of business (LoBs)). There is no difference no matter which matching solution (GLIM or LLM) is actually used by users. Further, LLM-based inference using, for example, CoT prompting, provides a solution for cold start scenarios, in which no or insufficient training data is available for an application. The inference results from the LLM-based inference can subsequently be used as training data for training GLIM models. For example, the inference results from LLM-based inference are stored and accumulated as historical data to be used to training GLIM model. In this manner, the unified service platform of the present disclosure provides a cohesive process for immediate consumption and service preparation of data matching services.

As another example, after sufficient training data is generated through LLM-based inference, users can choose to switch to GLIM-based inference. Here, GLIM models are created specifically for the data of the user and is more secure. For example, leakage of user data is avoided. Further, a GLIM model is more economic in cost and technical resources. For example, calls to LLM systems incur not only technical overhead, but financial overhead. As another example, the unified service platform of the present disclosure is compatible to classical ML service APIs. Even existing users, which have implemented GLIM services can be upgraded to the unified services platform without any change of integration APIs.

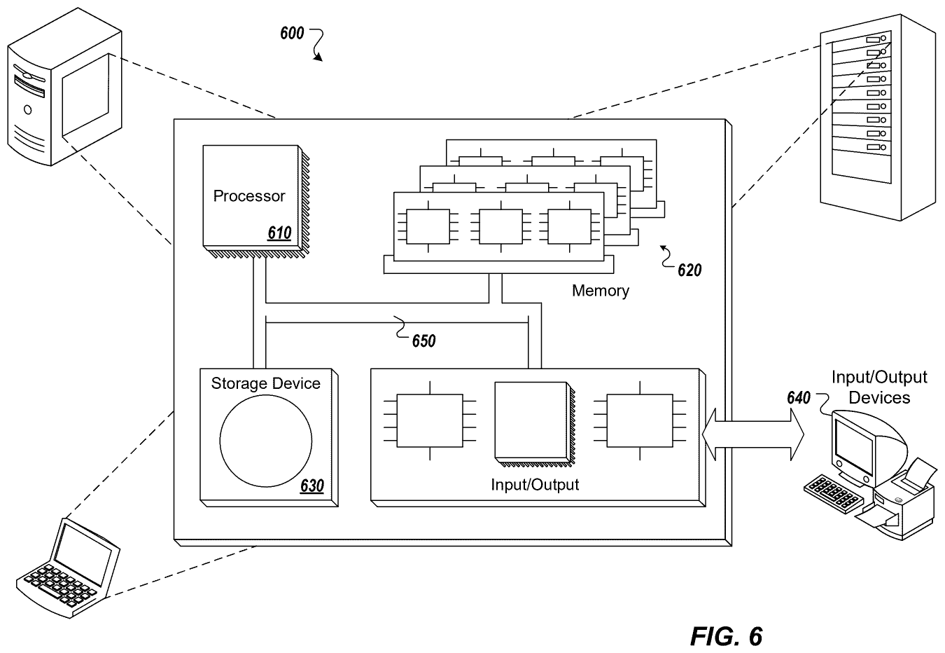

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for computer-executed entity matching using one or more machine learning (ML) models, the method being executed by one or more processors and comprising:
receiving a first inference request comprising first inference data; and
determining, from the first inference request, that generic line-item matching (GLIM)-based inference is to be executed, and in response:
transmitting a GLIM inference request comprising at least a portion of the first inference data and a model identifier,
retrieving a GLIM model from a model repository using the model identifier,
processing the at least a portion of the first inference data through the GLIM model to generate first inference results, and
returning the first inference results to a first application.

2. The method of claim 1, further comprising:
receiving a request to enable inference for the first application;
in response to the request, determining whether training data is available; and
in response to training data being available:
receiving the training data,
training the GLIM model using the training data,
storing the GLIM model in the model repository, and
providing an entry in an inference registry, the entry comprising an application identifier that uniquely identifies the first application and the model identifier.

3. The method of claim 2, wherein the request to enable inference for the first application is received by an AI-based agent that interacts with a user.

4. The method of claim 1, wherein the first inference request is received by a service gateway.

5. The method of claim 1, further comprising:
receiving a second inference request comprising second inference data; and
determining, from the second inference request, that large language model (LLM)-based inference is to be executed, and in response:
transmitting a LLM inference request comprising at least a portion of the second inference data and a prompt template identifier,
retrieving a prompt template from a prompt template repository using the prompt template identifier,
generating a prompt using the prompt template and at least a portion of the second inference data,
providing the prompt for processing through a LLM to generate second inference results, and
returning the second inference results to a second application.

6. The method of claim 5, further comprising:
receiving a request to enable inference for the second application;
in response to the request, determining whether training data is available; and
in response to training data being unavailable:
receiving a data schema, a task description, and a set of examples,
generating the prompt template based on the data schema, the task description, and the set of examples,
storing the prompt template in the prompt template repository, and
providing an entry in an inference registry, the entry comprising an application identifier that uniquely identifies the second application and the prompt template identifier.

7. The method of claim 6, wherein the request to enable inference for the second application is received by an AI-based agent that interacts with a user.

8. The method of claim 5, wherein the second inference request is received by a service gateway.

9. A non-transitory computer-readable storage medium coupled to one or more processors and having instructions stored thereon which, when executed by the one or more processors, cause the one or more processors to perform operations for computer-executed entity matching using one or more machine learning (ML) models, the operations comprising:
receiving a first inference request comprising first inference data; and
determining, from the first inference request, that generic line-item matching (GLIM)-based inference is to be executed, and in response:
transmitting a GLIM inference request comprising at least a portion of the first inference data and a model identifier,
retrieving a GLIM model from a model repository using the model identifier,
processing the at least a portion of the first inference data through the GLIM model to generate first inference results, and
returning the first inference results to a first application.

10. The non-transitory computer-readable storage medium of claim 9, wherein operations further comprise:
receiving a request to enable inference for the first application;
in response to the request, determining whether training data is available; and
in response to training data being available:
receiving the training data,
training the GLIM model using the training data,
storing the GLIM model in the model repository, and
providing an entry in an inference registry, the entry comprising an application identifier that uniquely identifies the first application and the model identifier.

11. The non-transitory computer-readable storage medium of claim 10, wherein the request to enable inference for the first application is received by an AI-based agent that interacts with a user.

12. The non-transitory computer-readable storage medium of claim 9, wherein the first inference request is received by a service gateway.

13. The non-transitory computer-readable storage medium of claim 9, wherein operations further comprise:
receiving a second inference request comprising second inference data; and
determining, from the second inference request, that large language model (LLM)-based inference is to be executed, and in response:
transmitting a LLM inference request comprising at least a portion of the second inference data and a prompt template identifier,
retrieving a prompt template from a prompt template repository using the prompt template identifier,
generating a prompt using the prompt template and at least a portion of the second inference data,
providing the prompt for processing through a LLM to generate second inference results, and
returning the second inference results to a second application.

14. The non-transitory computer-readable storage medium of claim 13, wherein operations further comprise:
receiving a request to enable inference for the second application;
in response to the request, determining whether training data is available; and
in response to training data being unavailable:
receiving a data schema, a task description, and a set of examples,
generating the prompt template based on the data schema, the task description, and the set of examples,
storing the prompt template in the prompt template repository, and
providing an entry in an inference registry, the entry comprising an application identifier that uniquely identifies the second application and the prompt template identifier.

15. The non-transitory computer-readable storage medium of claim 14, wherein the request to enable inference for the second application is received by an AI-based agent that interacts with a user.

16. A system, comprising:
a computing device; and
a computer-readable storage device coupled to the computing device and having instructions stored thereon which, when executed by the computing device, cause the computing device to perform operations for computer-executed entity matching using one or more machine learning (ML) models, the operations comprising:
receiving a first inference request comprising first inference data; and
determining, from the first inference request, that generic line-item matching (GLIM)-based inference is to be executed, and in response:
transmitting a GLIM inference request comprising at least a portion of the first inference data and a model identifier,
retrieving a GLIM model from a model repository using the model identifier,
processing the at least a portion of the first inference data through the GLIM model to generate first inference results, and
returning the first inference results to a first application.

17. The system of claim 16, wherein operations further comprise:
receiving a request to enable inference for the first application;
in response to the request, determining whether training data is available; and
in response to training data being available:
receiving the training data,
training the GLIM model using the training data,
storing the GLIM model in the model repository, and
providing an entry in an inference registry, the entry comprising an application identifier that uniquely identifies the first application and the model identifier.

18. The system of claim 17, wherein the request to enable inference for the first application is received by an AI-based agent that interacts with a user.

19. The system of claim 16, wherein the first inference request is received by a service gateway.

20. The system of claim 16, wherein operations further comprise:
receiving a second inference request comprising second inference data; and
determining, from the second inference request, that large language model (LLM)-based inference is to be executed, and in response:
transmitting a LLM inference request comprising at least a portion of the second inference data and a prompt template identifier,
retrieving a prompt template from a prompt template repository using the prompt template identifier,
generating a prompt using the prompt template and at least a portion of the second inference data,
providing the prompt for processing through a LLM to generate second inference results, and
returning the second inference results to a second application.
